(19) United States
(12) Patent Application Publication
(10) Pub. No.: US 2022/0103479 A1
(43) Pub. Date: Mar. 31, 2022

(54) TRANSMIT RATE BASED ON DETECTED AVAILABLE BANDWIDTH

(71) Applicant: Intel Corporation, Santa Clara, CA (US)

(72) Inventors: Pedro YEBENES SEGURA, San Jose, CA (US); Roberto PENARANDA CEBRIAN, Santa Clara, CA (US); Rong PAN, Saratoga, CA (US); Robert SOUTHWORTH, Chatsworth, CA (US); Allister ALEMANIA, North Plains, OR (US); Malek MUSLEH, Portland, OR (US)

(21) Appl. No.: 17/545,959

(22) Filed: Dec. 8, 2021

(51) Int. Cl. H04L 47/122; H04L 47/11; H04L 47/25; H04L 47/70

(52) U.S. Cl. CPC H04L 47/122; H04L 47/822; H04L 47/25; H04L 47/115

(57) ABSTRACT

Examples described herein relate to a sender network interface device transmitting one or more packet probes to a receiver device, when a link is underutilized, to request information concerning link or path utilization. Based on responses to the packet probes, the sender network interface device can determine a packet transmit rate of packets of one or more flows and adjust the packet transmit rate of packets of one or more flows to increase utilization of the link.

### BACKGROUND

Data Center Networks (DCNs) are platforms for executing workloads such as distributed software architectures, Deep Learning, and High Performance Computing (HPC). DCNs compute, store, and transfer large amounts of data. Cloud-Service-Providers (CSPs) that operate DCNs are to provide high throughput data computation and low latency of data transfer. However, DCNs can experience congestion arising from network packet traffic. Congestion control (CC) protocols are utilized to control network packet traffic. CC protocols rely on accurate indications of congestion to improve utilization of a network. However, in cases of limited available congestion information, ineffective changes may be made to network packet traffic.

### BRIEF DESCRIPTION OF THE DRAWINGS

FIG. 1 depicts an example system.

FIG. 2 depicts an example system.

FIG. 3 depicts an example process.

FIG. 4 depicts an example process.

FIG. 5 depicts an example network interface device.

FIG. 6 depicts an example switch.

FIG. 7 depicts an example computing system.

### DETAILED DESCRIPTION

Explicit congestion notification (ECN) or packet dropping indicate whether congestion at a network interface device (e.g., switch) is present or not. Packet timestamps or queue lengths indicate a level of queuing in a network, but not the network's utilization relative to available bandwidth. After a congestion episode is over, to avoid creating congestion again, a congestion control protocol can slowly ramp up a transmit rate of packets of flow. However, packet injection rates may be too slow to increase and not fully utilize available link bandwidth.

In some examples, a sender network interface device can transmit one or more packet probes to the receiver network interface device, when a link is underutilized, to request information concerning link or path utilization. In some examples, switches and the receiver network interface device do not generate or send probes unless the link is underutilized. Based on responses to the packet probes, the sender network interface device can determine a packet transmit rate of packets of one or more flows, and adjust the packet transmit rate of packets of one or more flows to increase utilization of the link.

Some examples include a sender network interface device configured to, based on clearing of a congestion state in a transmit path, transmit a packet probe to a receiver device to cause the receiver device to transmit at least one path congestion information to the sender network interface device. In some examples, a sender network interface device can send multiple probe packets to a receiver network interface device or multiple packets with flags that indicate switches along a path from the sender network interface device to the receiver network interface device are to add inband-network telemetry (INT) information in headers sent to the receiver network interface device. For an example description of INT, see, e.g., “In-band Network Telemetry (INT) Dataplane Specification,” Version 2.1 (2020), as well as earlier versions, later versions, or revisions thereof. INT can include congestion information such as: an identification of a path of at least one packet, packet forward rules applied to the packet, duration a packet is stored in a packet queue at a switch, number of other packets that share a queue with a packet. In some examples, packets based on Inband Flow Analyzer (IFA) probe (e.g., Internet Engineering Task Force (IETF) draft Inband Flow Analyzer, draft-kumar-ifa-00 (September 2018)) can be transmitted to one or more switches along the path from the sender network interface device to the receiver network interface device to request congestion information from the switches.

In response to receipt of the at least one path congestion information, the sender network interface device can increase a transmit rate of packets associated with a flow based on the at least one congestion information. In some examples, clearing of a congestion state in a path can be identified by the sender network interface device based on measured round trip time (RTT) and baseline RTT or non-receipt of ECN markings for an amount of time. Path congestion information can include one or more of: queue depth, bytes transmitted by a switch or forwarding element, an identification of a path of at least one packet, duration a packet is stored in a packet queue at a switch, number of other packets that share a queue with a packet, utilization value, and so forth.

Based on the at least one congestion information, the sender network interface device can determine path or link utilization and compute a congestion window size or transmit rate value based on the determined path or link utilization and peak link utilization. A congestion window can be a number of packets that are transmitted or a total number of bytes or size of packets that have been transmitted. The sender network interface device can increase a rate of packet transmission to attempt to utilize available bandwidth of a path or link.

Accordingly, some examples can reduce an amount of packet processing utilization and network bandwidth to generate and convey congestion information to the sender network interface device by providing congestion information in scenarios when a link or path is identified as uncongested or by providing congestion information at the request of a sender network interface device. Some examples can increase packet injection rate or congestion window based on measured network congestion.

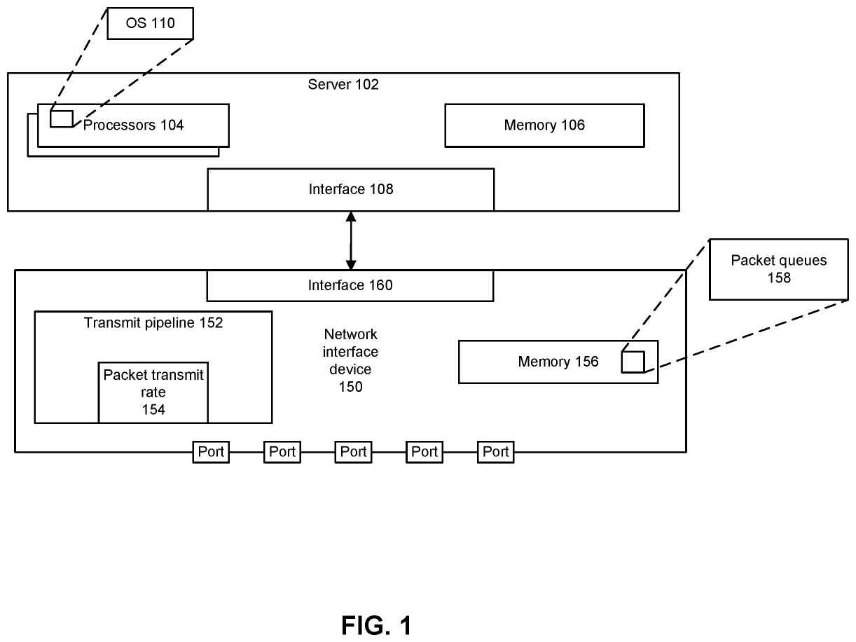

FIG. 1 depicts an example system. Server 102 can include or access one or more processors 104, memory 106, and device interface 108, among other components described herein (e.g., accelerator devices, interconnects, and other circuitry). Processors 104 can execute one or more applications (e.g., microservices, virtual machines (VMs), containers, or other distributed or virtualized execution environments) that request transmission of packets or process packets received by network interface device 150. In some examples, one or more processors 104 can execute a driver to configure network interface device 150 to transmit one or more packet probes to a receiver network interface device, when a link is underutilized, to request information concerning link or path utilization; and based on responses to the packet probes, determine a packet transmit rate of packets of one or more flows and adjust the packet transmit rate of packets of one or more flows to increase utilization of the link. In some examples, a link can used as part of a microservice-to-microservice communications using a service mesh.

Referring to network interface device 150, transmit pipeline 152 can select a packet for transmission from packet queues 158 in memory 156, or packet buffer in memory 106. Memory 156 can be implemented as a volatile memory device including a cache (e.g., Level 1 (L1), Level 2 (L2), Level 3 (L3), and/or last level cache (LLC)). Note that while memory 156 is shown as part of network interface device 150, memory 156 can be part of server 102 or another device.

Transmit pipeline 152 can determine whether a congestion notification message has been received such as Congestion Notification Packets (CNPs), Explicit Congestion Notification (ECN) or Priority-Flow-Control (PFC). CNPs, ECN, or PFC can cause transmit pipeline 152 to reduce a rate of packet transmission and potentially reduce network congestion.

Transmit pipeline 152 can detect whether congestion is not present for a flow or whether a state of a flow has changed from congested to another state. For example, based on receipt of non-receipt of ECN markings for an amount of time, transmit pipeline 152 can determine congestion is not present for a flow. For example, based on a measured round trip time (RTT) decreasing or being approximately equal to a baseline RTT, transmit pipeline 152 can determine congestion is not present for a flow. RTT can be determined based on a time between transmission of a packet and time of receipt for an associated receipt acknowledgement (ACK) by a receiver network interface device. A baseline RTT can represent a lowest RTT value such as when a network does not transmit packet.

For example, transmit pipeline 152 can utilize a congestion control protocol to detect when a flow does not experience congestion and can trigger phases for increasing packet transmit rate as one or more of: fast recovery, hyper increase, multiplicative increase, or congestion-level based adjustment of transmit rate as described herein. Examples of congestion control protocols can include Data Center Quantized Congestion Notification (DCQCN) (e.g., M. Alizadeh, A. Greenberg, D. A. Maltz, J. Padhye, P. Patel, B. Prabhakar, S. Sengupta and M. Sridharan, “Data Center TCP (DCTCP),” in SIGCOMM, New Delhi, India, 2010); Timely (e.g., R. Mittal, V. T. L. N. Dukkipati, E. Blem, H. Wassel, M. Ghobadi, A. Vandat, Y. Wang, D. Wetherall and D. Zats, “TIMELY: RTT-based Congestion Control for the Datacenter,” in SIGCOMM, London, U K, 2015); Swift (e.g., G. Kumar, N. Dukkipati, K. Jang, H. M. G. Wassel, X. Wu, B. Montazeri, Y. Wang, K. Springborn, C. Alfeld, M. Ryan, D. Wetherall and A. Vandat, “Swift: Delay is Simple and Effective for Congestion Control in the Datacenter,” in SIGCOMM 20, New York, N.Y., USA, 2020); and/or High Precision Congestion Control (HPCC) (e.g., Li et al., “HPCC: High Precision Congestion Control” SIGCOMM (2019)).

Based on a determination that congestion is not present for a flow, transmit pipeline 152 can request network congestion information for the flow from one or more switches in a path of transit of packets of the flow and the receiver network interface device. For example, transmit pipeline 152 can cause one or more congestion information requesting packets to be transmitted to a receiver network interface device as well as one or more switches in a path of packets of the flow from network interface device 150 to the sender network interface device. In some examples, a standardized or proprietary reliable transport protocol can utilize congestion information in connection with determining whether packets have been received by a recipient.

A congestion information requesting packet can request transmission to network interface device 150 of congestion information. Congestion information can include one or more of: queue occupancy or depth, bytes transmitted by a switch or forwarding element, an identification of a path of at least one packet, duration a packet is stored in a packet queue at a switch, number of other packets that share a queue with a packet, egress timestamp, egress port transmit (TX) bandwidth link utilization, utilization value, and so forth. Some congestion information is generated by one or more switch devices in a path from network interface device 150 to a receiver network interface device can add the congestion information into probe packet headers. The receiver network interface device can send the congestion information to network interface device 150 in an ACK packet or packets. Some examples of congestion information are described in The P4.org Applications working group, “In-band Network Telemetry (INT) Dataplane Specification” (2020). A utilization value (U value) can be consistent with Li et al., “HPCC: High Precision Congestion Control” SIGCOMM (2019). In some examples, a congestion information requesting packet can be based on IFA probe to request congestion information from the switches.

Based on received congestion information for a flow, transmit pipeline 152 can adjust packet transmit rate 154 to adjust a transmit rate of packets of the flow or a congestion window of the flow. For example, an amount of adjustment to a transmit rate of packets of the flow or a congestion window of the flow can be based on a determined level of congestion. For example, a transmit rate of packets of the flow or a congestion window of the flow can be increased to approximately achieve full utilization of available bandwidth for the flow through the path or link between network interface device 150 and the receiver network interface device.

An example code segment to perform estimation of utilization performed by network interface device 150 (e.g., sender network interface device) is described next. At least two measures of congestion information are used to determine utilization based on ack.L and prevAck.L. In some examples, if a switch or receiver network interface device measures or determines utilization, the switch or receiver network interface device can send the utilization in a packet to network interface device 150 instead of network interface device 150 calculating utilization based on congestion information at different times.

In the example code segment, ack.L is an array of the INT headers for the switches that the packets crossed. Variable ack.L can include congestion information such as one or more of: glen (queue length), txBytes (bytes transmitted by a switch to different links), is (timestamp), and BW (maximum capable bandwidth). Variable prevAck.L can represent an array with congestion information stored (e.g., in a previous INT header).

| | |
|---|---|
| 1 | function get_utilization(ack) |
| 2 | maxU = 0; // To record the most utilized link |
| 3 | for each link i on the path do |
| 4 | txRate = (ack.L[i].txBytes − prevAck.L[i].txBytes) |
| 5 | / (ack.L[i].ts − prevAck.L[i].ts); |
| 6 | u = min(ack.L[i].qlen, prevAck.L[i].qlen)/ (ack.L[i].BW * baseRTT) |
| 7 | + txRate / ack.L[i].BW; |
| 8 | if u > maxU then |
| 9 | maxU = u; |
| 10 | return maxU . |

At lines (4) and (5), txRate determines a transmit rate based on a difference between bytes transmitted and the queue length in a time interval. The time interval can be a default value such as half base RTT or other values. At lines (6) and (7), variable u can measure utilization, such as a percentage of bandwidth available for a particular path. For example, given a current queue length (backlog), and RTT (e.g., bandwidth delay product), a bandwidth can be calculated that is to carry packets through the path. Utilization can be more than 100% of bandwidth available for a particular path, where more than available bandwidth is to be allocated to clear a packet backlog. At lines (8) and (9), a utilization is picked as a highest utilization encountered.

After determination of the utilization, the injection or transmit rate of network interface device 150 can be adjusted by dividing a transmit rate or the congestion window by the utilization percentage. In some examples, a revised congestion window size (cwnd) can be determined based on: new_cwnd=current_cwnd/utilization. In some cases, injection rate (inj_rate) can be modified based on: new_inj_rate=current inj_rate/utilization. For example, if the utilization is >1, the cwnd or injection value rate rises, whereas if the utilization is <1, the cwnd or injection rate value decreases.

For example, in a scenario where two flows are injecting at a rate of 25% and 15%, and utilization is 40% of available bandwidth, a next (higher) transmit rate for the flows can be 25%/40%=62.5% of available bandwidth and 15%/40%=37.5% of available bandwidth, respectively.

A flow can be a sequence of packets being transferred between two endpoints, generally representing a single session using a known protocol. Accordingly, a flow can be identified by a set of defined tuples and, for routing purpose, a flow is identified by the two tuples that identify the endpoints, e.g., the source and destination addresses. For content-based services (e.g., load balancer, firewall, intrusion detection system, etc.), flows can be discriminated at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

A packet may be used herein to refer to various formatted collections of bits that may be sent across a network, such as Ethernet frames, IP packets, TCP segments, UDP datagrams, etc. Also, as used in this document, references to L2, L3, L4, and L7 layers (layer 2, layer 3, layer 4, and layer 7) are references respectively to the second data link layer, the third network layer, the fourth transport layer, and the seventh application layer of the OSI (Open System Interconnection) layer model.

Network interface device 150 can be implemented as one or more of: a network interface controller (NIC), a remote direct memory access (RDMA)-enabled NIC, SmartNIC, router, switch, forwarding element, infrastructure processing unit (IPU), data processing unit (DPU), or network-attached appliance (e.g., storage, memory, accelerator, processors, security), and so forth.

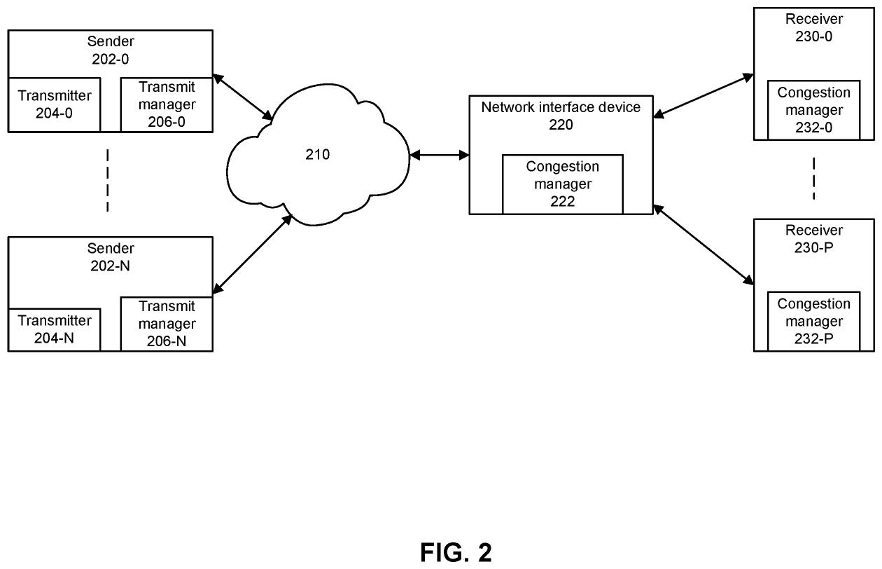

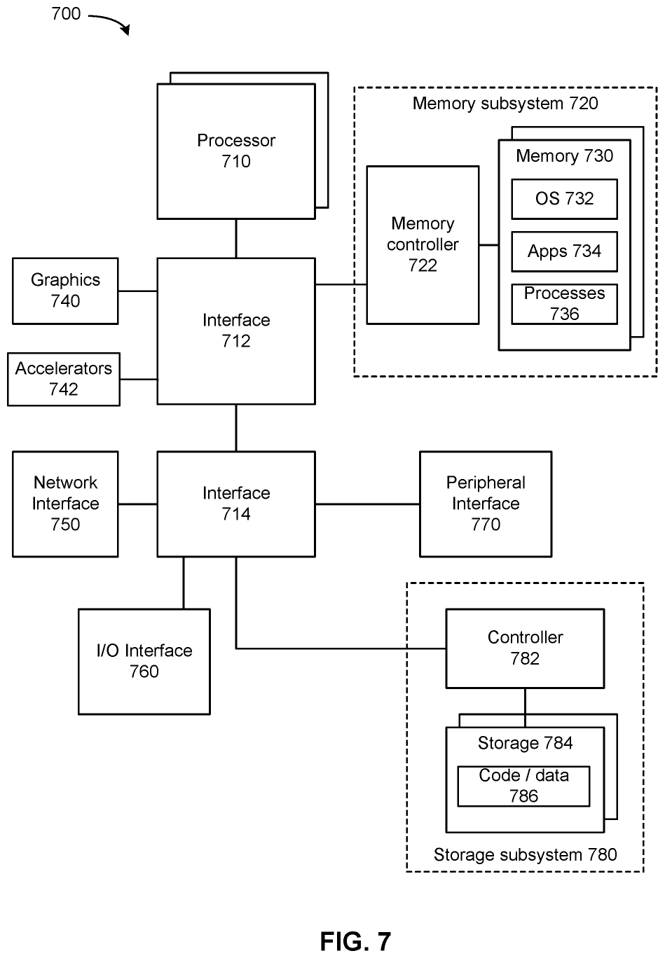

FIG. 2 depicts an example system. Sender nodes 202-0 to 202-N can transmit packets associated with one or more flows using respective transmitters 204-0 to 204-N, where N≥1. Example implementations of sender nodes 202-0 to 202-N are described herein with respect to FIGS. 1 and 7 among other places. Transmitters 204-0 to 204-N can send packets associated with one or more flows to one or more of receivers 230-0 to 230-P, where P≥1, through network 210 and network interface device 220. In a manner described herein, one or more of transmit managers 206-0 to 206-N of respective senders 202-0 to 202-N can perform one or more of: (1) determine if congestion condition has cleared for a flow and (2) based on a determination that congestion condition has cleared for the flow, (a) determine a utilization of a path for packets of the flow to a receiver among receivers 230-0 to 230-P and (b) adjust a transmit rate of packets of the flow based on the determination utilization and an available bandwidth to packets of the flow in the path.

To determine utilization of a path for packets of the flow to a receiver among receivers 230-0 to 230-P, one or more of transmitters 204-0 to 204-N can send one or more probe packets or packets that request congestion information from network interface device 220 (e.g., a switch of forwarding element) and/or one or more of receivers 230-0 to 230-P.

In network interface device 220, congestion manager 222 and in receivers 230-0 to 230-P, congestion managers 232-0 to 232-P can generate congestion information, described herein, and provide the congestion information to a sender of the one or more probe packets or packets that request congestion information.

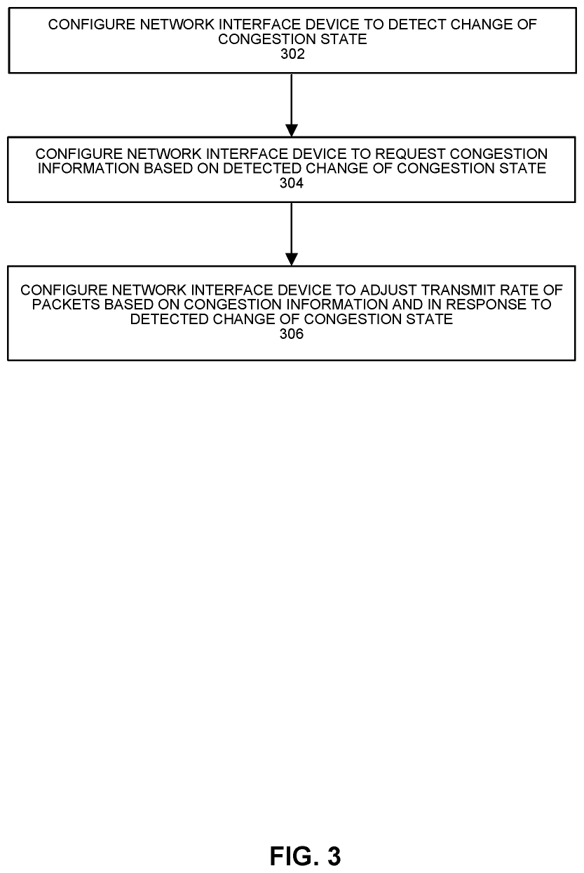

FIG. 3 depicts an example process. The process can be performed by an operating system, driver, orchestrator, or virtual switch (e.g., Open vSwitch) executed by a server. At 302, the driver can configure a network interface device to detect whether a state of a path has changed from congested. For example, the path can be a route from a sender network interface device through one or more switches to a receiver network interface device. A change of a state of a path from congested can be to uncongested or less congested. At 304, the driver can configure the network interface device to request congestion information from one or more network interface devices in the path based on detection of the state of a path changing from congested. At 306, the driver can configure the network interface device to adjust a transmit of packets transmitted through the path to increase utilization of the path based on detection of the state of a path changing from congested. For example, utilization of the path can be increased by increasing a transmit rate of packets through the path or increasing a congestion window for packets through the path.

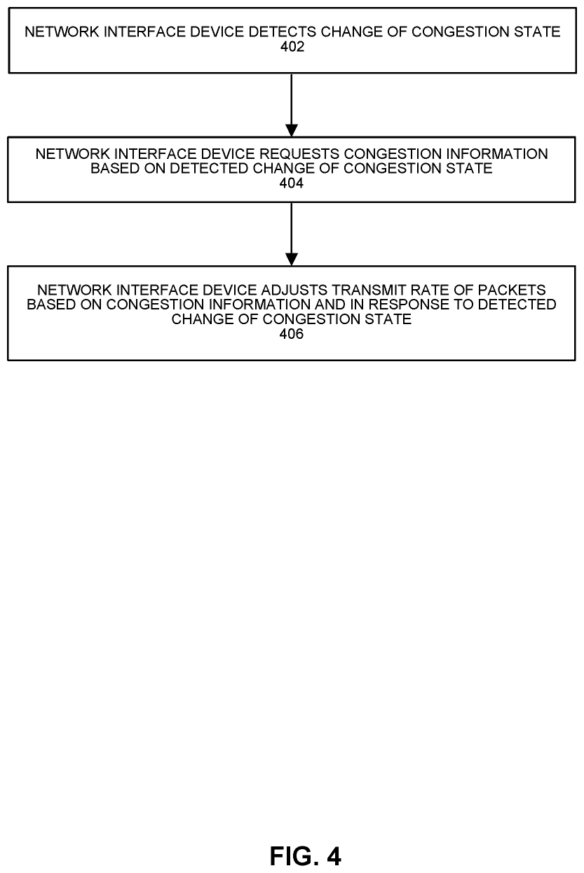

FIG. 4 depicts an example process. The process can be performed by a network interface device. At 402, the network interface device can detect whether a state of a path has changed from congested. Detection of whether a state of a path has changed from congested can be based on reduced RTT values and/or non-receipt of an ECN after receiving one or more ECN.

At 404, the network interface device can request one or more congestion information from devices in the path based on detection that the state of a path has changed from congested. At 406, the network interface device can adjust a transmit rate of packets directed to the path based on the congestion information to increase utilization of available bandwidth of the path. Examples of congestion information are described herein. In some examples, a congestion window size can be increased to increase utilization of available bandwidth of the path.

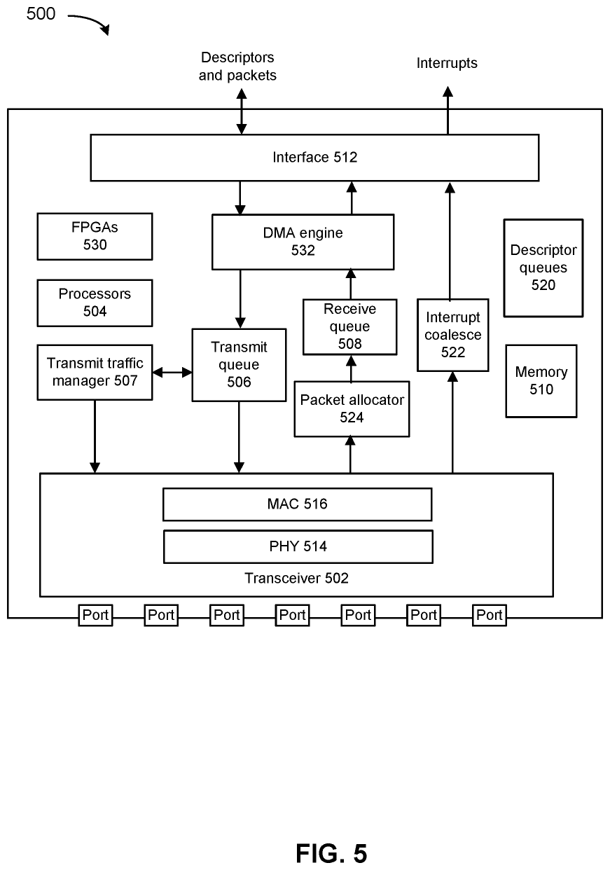

FIG. 5 depicts an example network interface device. Various processor resources in the network interface can determine if congestion associated with a path or flow has ended or lessened, transmit one or more packet probes to a receiver network interface device to request information concerning link or path utilization, and based on responses to the packet probes, determine a packet transmit rate of packets of one or more flows and adjust the packet transmit rate of packets of one or more flows to increase utilization of the link. In some examples, network interface 500 can be implemented as a network interface controller, network interface card, a host fabric interface (HFI), or host bus adapter (HBA), and such examples can be interchangeable. Network interface 500 can be coupled to one or more servers using a bus, PCIe, CXL, or DDR. Network interface 500 may be embodied as part of a system-on-a-chip (SoC) that includes one or more processors, or included on a multichip package that also contains one or more processors.

Some examples of network device 500 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 500 can include transceiver 502, processors 504, transmit queue 506, receive queue 508, memory 510, and bus interface 512, and DMA engine 532. Transceiver 502 can be capable of receiving and transmitting packets in conformance with the applicable protocols such as Ethernet as described in IEEE 802.3, although other protocols may be used. Transceiver 502 can receive and transmit packets from and to a network via a network medium (not depicted). Transceiver 502 can include PHY circuitry 514 and media access control (MAC) circuitry 516. PHY circuitry 514 can include encoding and decoding circuitry (not shown) to encode and decode data packets according to applicable physical layer specifications or standards. MAC circuitry 516 can be configured to perform MAC address filtering on received packets, process MAC headers of received packets by verifying data integrity, remove preambles and padding, and provide packet content for processing by higher layers. MAC circuitry 516 can be configured to assemble data to be transmitted into packets, that include destination and source addresses along with network control information and error detection hash values.

Processors 504 can be any a combination of a: processor, core, graphics processing unit (GPU), field programmable gate array (FPGA), application specific integrated circuit (ASIC), or other programmable hardware device that allow programming of network interface 500. For example, a “smart network interface” or SmartNIC can provide packet processing capabilities in the network interface using processors 504.

Processors 504 can include a programmable processing pipeline that is programmable by Programming Protocol-independent Packet Processors (P4), C, Python, Broadcom Network Programming Language (NPL), or x86 compatible executable binaries or other executable binaries. A programmable processing pipeline can include one or more match-action units (MAUs) that can schedule packets for transmission using one or multiple granularity lists, as described herein. Processors, FPGAs, other specialized processors, controllers, devices, and/or circuits can be used utilized for packet processing or packet modification. Ternary content-addressable memory (TCAM) can be used for parallel match-action or look-up operations on packet header content. In some examples, processors 504 can determine if congestion associated with a path or flow has ended or lessened, transmit one or more packet probes to a receiver network interface device to request information concerning link or path utilization, and based on responses to the packet probes, determine a packet transmit rate of packets of one or more flows and adjust the packet transmit rate of packets of one or more flows to increase utilization of the link or path.

Transmit traffic manager 507 can select a packet to allocate to a transmit time slot from among queues. Transmit traffic manager 507 can set and utilize a transmit rate and/or congestion window size based on examples described herein. Transmit traffic manager 507 can be implemented as part of processors 504 and/or FPGAs 530.

Packet allocator 524 can provide distribution of received packets for processing by multiple CPUs or cores using receive side scaling (RSS). When packet allocator 524 uses RSS, packet allocator 524 can calculate a hash or make another determination based on contents of a received packet to determine which CPU or core is to process a packet.

Interrupt coalesce 522 can perform interrupt moderation whereby network interface interrupt coalesce 522 waits for multiple packets to arrive, or for a time-out to expire, before generating an interrupt to host system to process received packet(s). Receive Segment Coalescing (RSC) can be performed by network interface 500 whereby portions of incoming packets are combined into segments of a packet. Network interface 500 provides this coalesced packet to an application.

Direct memory access (DMA) engine 532 can copy a packet header, packet payload, and/or descriptor directly from host memory to the network interface or vice versa, instead of copying the packet to an intermediate buffer at the host and then using another copy operation from the intermediate buffer to the destination buffer.

Memory 510 can be any type of volatile or non-volatile memory device and can store any queue or instructions used to program network interface 500. Transmit queue 506 can include data or references to data for transmission by network interface. Receive queue 508 can include data or references to data that was received by network interface from a network. Descriptor queues 520 can include descriptors that reference data or packets in transmit queue 506 or receive queue 508. Bus interface 512 can provide an interface with host device (not depicted). For example, bus interface 512 can be compatible with or based at least in part on PCI, PCI Express, PCI-x, Serial ATA, and/or USB (although other interconnection standards may be used), or proprietary variations thereof.

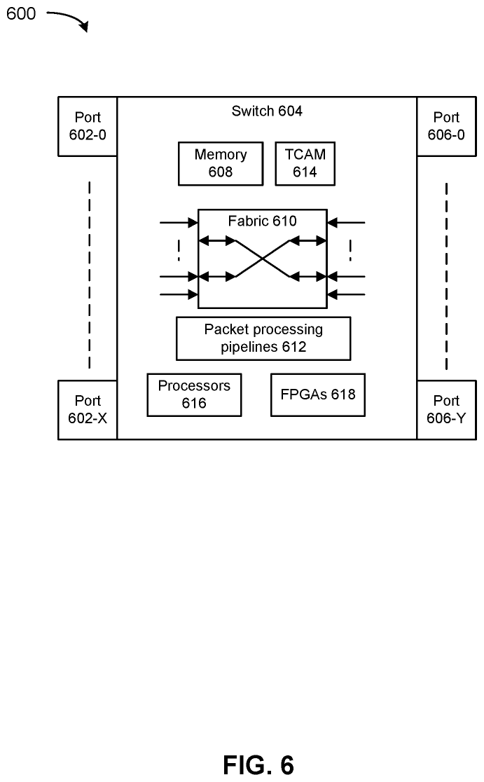

FIG. 6 depicts an example switch. Various examples can be used in or with the switch to measure and provide congestion information to a requester network interface device, as described herein. Switch 604 can route packets or frames of any format or in accordance with any specification from any port 602-0 to 602-X to any of ports 606-0 to 606-Y (or vice versa). Any of ports 602-0 to 602-X can be connected to a network of one or more interconnected devices. Similarly, any of ports 606-0 to 606-Y can be connected to a network of one or more interconnected devices.

In some examples, switch fabric 610 can provide routing of packets from one or more ingress ports for processing prior to egress from switch 604. Switch fabric 610 can be implemented as one or more multi-hop topologies, where example topologies include torus, butterflies, buffered multi-stage, etc., or shared memory switch fabric (SMSF), among other implementations. SMSF can be any switch fabric connected to ingress ports and all egress ports in the switch, where ingress subsystems write (store) packet segments into the fabric's memory, while the egress subsystems read (fetch) packet segments from the fabric's memory.

Memory 608 can be configured to store packets received at ports prior to egress from one or more ports. Packet processing pipelines 612 can determine which port to transfer packets or frames to using a table that maps packet characteristics with an associated output port. Packet processing pipelines 612 can be configured to perform match-action on received packets to identify packet processing rules and next hops using information stored in a ternary content-addressable memory (TCAM) tables or exact match tables in some examples. For example, match-action tables or circuitry can be used whereby a hash of a portion of a packet is used as an index to find an entry. Packet processing pipelines 612 can implement access control list (ACL) or packet drops due to queue overflow. Packet processing pipelines 612 can be configured to measure and provide congestion information to a requester network interface device, as described herein.

Configuration of operation of packet processing pipelines 612, including its data plane, can be programmed using example programming languages and manners described herein. Processors 616 and FPGAs 618 can be utilized for packet processing or modification.

FIG. 7 depicts an example computing system. Components of system 700 (e.g., processor 710, network interface 750, and so forth) to identify that a congestion state has changed for a link or path, request congestion information, and adjust transmit rate or congestion window based on congestion information, as described herein. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a display that provides an output to a user. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a fixed function or programmable offload engine that can be accessed or used by a processor 710. For example, an accelerator among accelerators 742 can provide compression (DC) capability, cryptography services such as public key encryption (PKE), cipher, hash/authentication capabilities, decryption, or other capabilities or services. In some examples, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 742 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others. In some examples, a driver can configure network interface 750 to identify that a congestion state has changed for a link or path, request congestion information, and adjust transmit rate or congestion window based on congestion information, as described herein. In some examples, a driver can enable or disable offload to network interface 750 to identify that a congestion state has changed for a link or path, request congestion information, and adjust transmit rate or congestion window based on congestion information, as described herein. A driver can advertise capability of network interface 750 to perform one or more aspects of network interface 750 to identify that a congestion state has changed for a link or path, request congestion information, and adjust transmit rate or congestion window based on congestion information, as described herein.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory.

Some examples of network interface 750 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). An example of a volatile memory include a cache. A memory subsystem as described herein may be compatible with a number of memory technologies.

A non-volatile memory (NVM) device is a memory whose state is determinate even if power is interrupted to the device. In one example, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, or NVM devices that use chalcogenide phase change material (for example, chalcogenide glass).

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Examples herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other examples described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, system-on-chip (SoC), and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in examples.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative examples. Furthermore, additional operations may be added or removed depending on the particular applications. Any combination of changes can be used and one of ordinary skill in the art with the benefit of this disclosure would understand the many variations, modifications, and alternative examples thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An example of the devices, systems, and methods may include any one or more, and any combination of, the examples described below.

An example includes a network interface device that includes circuitry to select a packet for transmission based on a departure time that ignores a pause command. In some examples, the pause command is a pause packet. In some examples, the pause command is a Priority Flow Control (PFC) packet.

Example 1 includes one or more examples, and includes an apparatus comprising: a network interface device comprising circuitry to: based on detection of a change of state of a flow from a congested state: transmit at least one packet to a receiver to cause transmission of at least one congestion information to the network interface device and increase a transmit rate of packets of the flow from the network interface device to the receiver based on the at least one congestion information and an available bandwidth for a path of packets of the flow.

Example 2 includes one or more examples, wherein the change of state of a flow from a congested state comprises one or more of: reduction in round trip time (RTT) or non-receipt of an explicit congestion notification (ECN).

Example 3 includes one or more examples, wherein the at least one packet comprises at least one packet with an indication to provide in-network telemetry (INT) information.

Example 4 includes one or more examples, wherein the at least one congestion information comprises one or more of: queue depth, bytes transmitted by a switch, an identification of the path of packets, duration a packet is stored in a packet queue at a switch, or a utilization of the path.

Example 5 includes one or more examples, wherein the utilization of the path is based on bandwidth of the path to transmit a packet backlog and the available bandwidth for the path.

Example 6 includes one or more examples, wherein the at least one congestion information comprises multiple congestion information.

Example 7 includes one or more examples, wherein the increase a transmit rate of packets of the flow from the network interface device to the receiver based on the at least one congestion information and an available bandwidth for a path of packets of the flow comprises increase a congestion window size.

Example 8 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Example 9 includes one or more examples, and includes a server to configure the network interface device to detect a change of state of a flow from a congested state, transmit at least one packet to a receiver to cause transmission of at least one congestion information to the network interface device, and increase a transmit rate of packets of the flow from the network interface device to the receiver based on the at least one congestion information and an available bandwidth for a path of packets of the flow.

Example 10 includes one or more examples, and includes a datacenter that comprises the server, the receiver, and at least one switch, wherein the at least one congestion information is based on congestion information associated with the at least one switch.

Example 11 includes one or more examples, and includes a non-transitory computer-readable medium comprising instructions stored thereon, that if executed by one or more processors, cause the one or more processors to: configure circuitry of a network interface device to: based on detection of a change of state of a flow from a congested state: transmit at least one packet to a receiver to cause transmission of at least one congestion information to the network interface device and increase a transmit rate of packets of the flow from the network interface device to the receiver based on the at least one congestion information and an available bandwidth for a path of packets of the flow.

Example 12 includes one or more examples, wherein the change of state of a flow from a congested state comprises one or more of: reduction in round trip time (RTT), non-receipt of an explicit congestion notification (ECN), or congestion information based on inband-network telemetry (INT).

Example 13 includes one or more examples, wherein the at least one congestion information comprises one or more of: queue depth, bytes transmitted by a switch, an identification of the path of the packets, duration a packet is stored in a packet queue at a switch, or a utilization of the path.

Example 14 includes one or more examples, wherein the utilization of the path is based on bandwidth of the path to transmit a packet backlog and the available bandwidth for the path.

Example 15 includes one or more examples, wherein the increase a transmit rate of packets of the flow from the network interface device to the receiver based on the at least one congestion information and an available bandwidth for a path of packets of the flow comprises increase a congestion window size.

Example 16 includes one or more examples, and includes a method comprising: at a network interface device: based on detection of a change of state of a flow from a congested state: transmit at least one packet to a receiver to cause transmission of at least one congestion information to the network interface device and increase a transmit rate of packets of the flow from the network interface device to the receiver based on the at least one congestion information and an available bandwidth for a path of packets of the flow.

Example 17 includes one or more examples, wherein the change of state of a flow from a congested state comprises one or more of: reduction in round trip time (RTT), non-receipt of an explicit congestion notification (ECN), or congestion information based on inband-network telemetry (INT).

Example 18 includes one or more examples, wherein the at least one congestion information comprises one or more of: queue depth, bytes transmitted by a switch, an identification of the path of the packets, duration a packet is stored in a packet queue at a switch, or a utilization of the path.

Example 19 includes one or more examples, wherein the utilization of the path is based on bandwidth of the path to transmit a packet backlog and the available bandwidth for the path.

Example 20 includes one or more examples, wherein the increase a transmit rate of packets of the flow from the network interface device to the receiver based on the at least one congestion information and an available bandwidth for a path of packets of the flow comprises increase a congestion window size.

What is claimed is:

1. An apparatus comprising:
a network interface device comprising circuitry to:
based on detection of a change of state of a flow from a congested state:
transmit at least one packet to a receiver to cause transmission of at least one congestion information to the network interface device and
increase a transmit rate of packets of the flow from the network interface device to the receiver based on the at least one congestion information and an available bandwidth for a path of packets of the flow.

2. The apparatus of claim 1, wherein the change of state of a flow from a congested state comprises one or more of: reduction in round trip time (RTT) or non-receipt of an explicit congestion notification (ECN).

3. The apparatus of claim 1, wherein the at least one packet comprises at least one packet with an indication to provide in-network telemetry (INT) information.

4. The apparatus of claim 1, wherein the at least one congestion information comprises one or more of: queue depth, bytes transmitted by a switch, an identification of the path of the packets, duration a packet is stored in a packet queue at a switch, or a utilization of the path.

5. The apparatus of claim 4, wherein the utilization of the path is based on bandwidth of the path to transmit a packet backlog and the available bandwidth for the path.

6. The apparatus of claim 1, wherein the at least one congestion information comprises multiple congestion information.

7. The apparatus of claim 1, wherein the increase a transmit rate of packets of the flow from the network interface device to the receiver based on the at least one congestion information and an available bandwidth for a path of packets of the flow comprises increase a congestion window size.

8. The apparatus of claim 1, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

9. The apparatus of claim 1, comprising a server to configure the network interface device to detect a change of state of a flow from a congested state, transmit at least one packet to a receiver to cause transmission of at least one congestion information to the network interface device, and increase a transmit rate of packets of the flow from the network interface device to the receiver based on the at least one congestion information and an available bandwidth for a path of packets of the flow.

10. The apparatus of claim 9, comprising a datacenter that comprises the server, the receiver, and at least one switch, wherein the at least one congestion information is based on congestion information associated with the at least one switch.

11. A non-transitory computer-readable medium comprising instructions stored thereon, that if executed by one or more processors, cause the one or more processors to:
configure circuitry of a network interface device to:
based on detection of a change of state of a flow from a congested state:
transmit at least one packet to a receiver to cause transmission of at least one congestion information to the network interface device and
increase a transmit rate of packets of the flow from the network interface device to the receiver based on the at least one congestion information and an available bandwidth for a path of packets of the flow.

12. The computer-readable medium of claim 11, wherein the change of state of a flow from a congested state comprises one or more of: reduction in round trip time (RTT), non-receipt of an explicit congestion notification (ECN), or congestion information based on inband-network telemetry (INT).

13. The computer-readable medium of claim 11, wherein the at least one congestion information comprises one or more of: queue depth, bytes transmitted by a switch, an identification of the path of the packets, duration a packet is stored in a packet queue at a switch, or a utilization of the path.

14. The computer-readable medium of claim 13, wherein the utilization of the path is based on bandwidth of the path to transmit a packet backlog and the available bandwidth for the path.

15. The computer-readable medium of claim 11, wherein the increase a transmit rate of packets of the flow from the network interface device to the receiver based on the at least one congestion information and an available bandwidth for a path of packets of the flow comprises increase a congestion window size.

16. A method comprising:
at a network interface device:
based on detection of a change of state of a flow from a congested state:
transmit at least one packet to a receiver to cause transmission of at least one congestion information to the network interface device and
increase a transmit rate of packets of the flow from the network interface device to the receiver based on the at least one congestion information and an available bandwidth for a path of packets of the flow.

17. The method of claim 16, wherein the change of state of a flow from a congested state comprises one or more of: reduction in round trip time (RTT), non-receipt of an explicit congestion notification (ECN), or congestion information based on inband-network telemetry (INT).

18. The method of claim 16, wherein the at least one congestion information comprises one or more of: queue depth, bytes transmitted by a switch, an identification of the path of packets, duration a packet is stored in a packet queue at a switch, or a utilization of the path.

19. The method of claim 18, wherein the utilization of the path is based on bandwidth of the path to transmit a packet backlog and the available bandwidth for the path.

20. The method of claim 16, wherein the increase a transmit rate of packets of the flow from the network interface device to the receiver based on the at least one congestion information and an available bandwidth for a path of packets of the flow comprises increase a congestion window size.
